(19) United States
(12) Patent Application Publication
(10) Pub. No.: US 2013/0179717 A1
(43) Pub. Date: Jul. 11, 2013

(54) ELECTRONIC SYSTEM WITH POWER SAVING FUNCTION

(71) Applicant: JMicron Technology Corp., Hsin-Chu (TW)

(72) Inventors: Kuang-Jung Chang, New Taipei City (TW); Kuo-Hua Yuan, Hsinchu City (TW)

(73) Assignee: JMicron Technology Corp., Hsin-Chu (TW)

(21) Appl. No.: 13/684,173

(22) Filed: Nov. 22, 2012

(30) Foreign Application Priority Data
Jan. 11, 2012 (TW) 101101068

(51) Int. Cl. G06F 1/32

(52) U.S. Cl. CPC G06F 1/3287
USPC 713/324

(57) ABSTRACT

The present invention provides an electronic system with power saving function. In a first embodiment, the electronic system comprises a processing unit and a storage device. The storage device has a transmission interface, and the storage device is coupled to the processing unit via the transmission interface, wherein when the electronic system enters into a hibernate mode, the processing unit will turn off power supply of the storage device completely via the transmission interface. In a second embodiment, the electronic system comprises a processing unit and a storage device. The storage device has a transmission interface and an independent signal pin, and the storage device is coupled to the processing unit via the transmission interface and the independent signal pin, wherein when the electronic system enters into a hibernate mode, the processing unit will turn off power supply of the storage device completely via the independent signal pin.

### BACKGROUND OF THE INVENTION

1. Field of the Invention

The present invention relates to an electronic system, and more particularly, to an electronic system with power saving function.

2. Description of the Prior Art

In general , when a traditional computer system (such as a PC, a notebook computer, an embedded computer, or a tablet computer) enters into a hibernate mode, the traditional computer system will set a storage device (such as a hard disk or a Solid State Drive (SSD)) connected to a high speed transmission interface (such as a Serial Advanced Technology Attachment (SATA) interface or a Peripheral Component Interconnect Express (PCI-E) interface) to a standby mode. However, the standby mode dose not completely turn off power supply of the storage device, and thus the storage device constantly consumes power in the standby mode.

### SUMMARY OF THE INVENTION

It is therefore one of the objectives of the present invention to provide an electronic system with power saving function, so as to solve the above problem.

In accordance with an embodiment of the present invention, an electronic system with power saving function is disclosed. The electronic system comprises: a processing unit and a storage device. The storage device has a transmission interface, and the storage device is coupled to the processing unit via the transmission interface, wherein when the electronic system enters into a hibernate mode, the processing unit will turn off power supply of the storage device completely via the transmission interface.

In accordance with an embodiment of the present invention, an electronic system with power saving function is disclosed. The electronic system comprises: a processing unit and a storage device. The storage device has a transmission interface, and the storage device is coupled to the processing unit via the transmission interface, wherein when the electronic system enters into a normal operation mode from a hibernate mode, the processing unit will turn on power supply of the storage device via the transmission interface.

In accordance with an embodiment of the present invention, an electronic system with power saving function is disclosed. The electronic system comprises: a processing unit and a storage device. The storage device has a transmission interface and an independent signal pin, and the storage device is coupled to the processing unit via the transmission interface and the independent signal pin, wherein when the electronic system enters into a hibernate mode, the processing unit will turn off power supply of the storage device completely via the independent signal pin.

In accordance with an embodiment of the present invention, an electronic system with power saving function is disclosed. The electronic system comprises: a processing unit and a storage device. The storage device has a transmission interface and an independent signal pin, and the storage device is coupled to the processing unit via the transmission interface and the independent signal pin, wherein when the electronic system enters into a normal operation mode from a hibernate mode, the processing unit will turn on power supply of the storage device via the independent signal pin.

Briefly summarized, the electronic system disclosed by the present invention can turn off power supply of the storage device in the electronic system completely after the electronic system enters into the hibernate mode, so as to save power.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of an electronic system with power saving function in accordance with a first embodiment of the present invention.

FIG. 2 shows a simplified block diagram of an electronic system with power saving function in accordance with a second embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

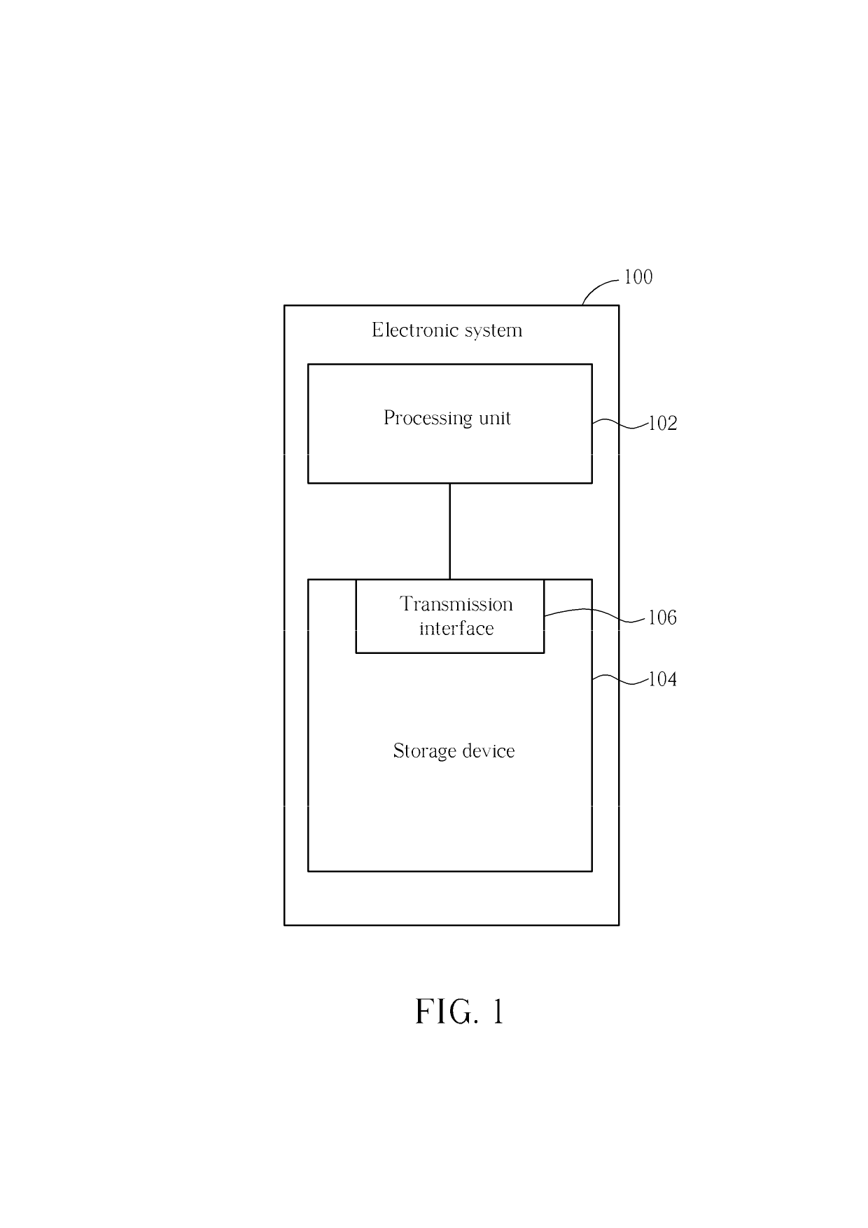

Please refer to FIG. 1. FIG. 1 shows a simplified block diagram of an electronic system 100 with power saving function in accordance with a first embodiment of the present invention, wherein the electronic system 100 can be a PC, a notebook computer, an embedded computer, or a tablet computer. As shown in FIG. 1, then electronic system 100 comprises: a processing unit 102 and a storage device 104, wherein the electronic system 100 can be a PC, a notebook computer, an embedded computer, or a tablet computer, and the storage device is a Solid State Drive (SSD). The storage device 104 has a transmission interface 106, and the storage device 104 is coupled to the processing unit 102 via the transmission interface 106, wherein the transmission interface 106 can be a Serial Advanced Technology Attachment (SATA) interface or a Peripheral Component Interconnect Express (PCI-E) interface. When the electronic system 100 enters into a hibernate mode, the processing unit 102 will turn off power supply of the storage device 104 completely via the transmission interface 106, wherein the processing unit 102 turns off power supply of the storage device 104 completely via a specific signal pin (not shown) of the transmission interface 106, so as to save power. For example, according to the spec of SATA interface or PCI-E interface, since there is at least a signal pin having no function, the present invention can set the at least a signal pin to be the specific signal pin, so that the processing unit 102 can turn off power supply of the storage device 104 completely via the specific signal pin, so as to save power. In addition, when the electronic system 100 enters into a normal operation mode from the hibernate mode, the processing unit 102 also can turn on power supply of the storage device via the transmission interface 106. In other words, the processing unit 102 also can turn on power supply of the storage device via the specific signal pin of the transmission interface 106. Please note that the above embodiment is only for an illustrative purpose and is not meant to be a limitation of the present invention.

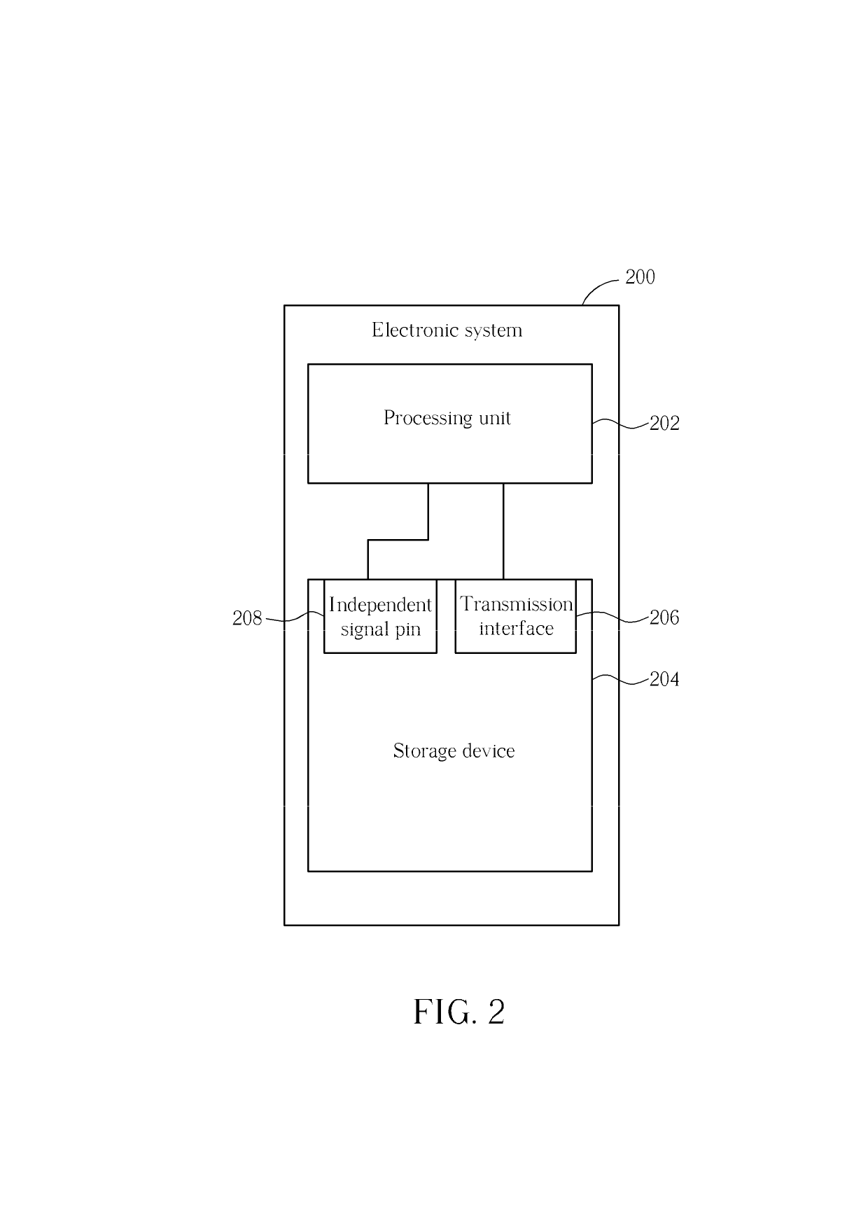

Please refer to FIG. 2. FIG. 2 shows a simplified block diagram of an electronic system 200 with power saving function in accordance with a second embodiment of the present invention, wherein the electronic system 200 can be a PC, a notebook computer, an embedded computer, or a tablet computer. As shown in FIG. 2, then electronic system 200 comprises: a processing unit 202 and a storage device 204, wherein the electronic system 200 can be a PC, a notebook computer, an embedded computer, or a tablet computer, and the storage device is a Solid State Drive (SSD). The storage device 204 has a transmission interface 206 and an independent signal pin 208, wherein the independent signal pin 208 is completely independent from the transmission interface 206, and the independent signal pin 208 is not a part of the transmission interface 206. The storage device 204 is coupled to the processing unit 202 via the transmission interface 206 and the independent signal pin 208, wherein the transmission interface 206 can be a Serial Advanced Technology Attachment (SATA) interface or a Peripheral Component Interconnect Express (PCI-E) interface. When the electronic system 200 enters into a hibernate mode, the processing unit 202 will turn off power supply of the storage device 204 completely via the independent signal pin 208, so as to save power. In addition, when the electronic system 200 enters into a normal operation mode from the hibernate mode, the processing unit 202 also can turn on power supply of the storage device via the independent signal pin 208. Please note that the above embodiment is only for an illustrative purpose and is not meant to be a limitation of the present invention.

Briefly summarized, the electronic system disclosed by the present invention can turn off power supply of the storage device in the electronic system completely after the electronic system enters into the hibernate mode, so as to save power.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic system with power saving function, comprising:
a processing unit; and
a storage device, having a transmission interface, and the storage device being coupled to the processing unit via the transmission interface;
wherein when the electronic system enters into a hibernate mode, the processing unit will turn off power supply of the storage device completely via the transmission interface.

2. The electronic system of claim 1, wherein the processing unit turns off power supply of the storage device completely via a specific signal pin of the transmission interface.

3. The electronic system of claim 1, wherein the electronic system is a PC, a notebook computer, an embedded computer, or a tablet computer, and the storage device is a Solid State Drive (SSD).

4. The electronic system of claim 1, wherein the transmission interface is a Serial Advanced Technology Attachment (SATA) interface or a Peripheral Component Interconnect Express (PCI-E) interface.

5. An electronic system with power saving function, comprising:
a processing unit; and
a storage device, having a transmission interface, and the storage device being coupled to the processing unit via the transmission interface;
wherein when the electronic system enters into a normal operation mode from a hibernate mode, the processing unit will turn on power supply of the storage device via the transmission interface.

6. The electronic system of claim 5, wherein the processing unit turns on power supply of the storage device completely via a specific signal pin of the transmission interface.

7. The electronic system of claim 5, wherein the electronic system is a PC, a notebook computer, an embedded computer, or a tablet computer, and the storage device is a Solid State Drive (SSD).

8. The electronic system of claim 5, wherein the transmission interface is a Serial Advanced Technology Attachment (SATA) interface or a Peripheral Component Interconnect Express (PCI-E) interface.

9. An electronic system with power saving function, comprising:
a processing unit; and
a storage device, having a transmission interface and an independent signal pin, and the storage device being coupled to the processing unit via the transmission interface and the independent signal pin;
wherein when the electronic system enters into a hibernate mode, the processing unit will turn off power supply of the storage device completely via the independent signal pin.

10. The electronic system of claim 9, wherein the electronic system is a PC, a notebook computer, an embedded computer, or a tablet computer, and the storage device is a Solid State Drive (SSD).

11. The electronic system of claim 9, wherein the transmission interface is a Serial Advanced Technology Attachment (SATA) interface or a Peripheral Component Interconnect Express (PCI-E) interface.

12. An electronic system with power saving function, comprising:
a processing unit; and
a storage device, having a transmission interface and an independent signal pin, and the storage device being coupled to the processing unit via the transmission interface and the independent signal pin;
wherein when the electronic system enters into a normal operation mode from a hibernate mode, the processing unit will turn on power supply of the storage device via the independent signal pin.

13. The electronic system of claim 12, wherein the electronic system is a PC, a notebook computer, an embedded computer, or a tablet computer, and the storage device is a Solid State Drive (SSD).

14. The electronic system of claim 12, wherein the transmission interface is a Serial Advanced Technology Attachment (SATA) interface or a Peripheral Component Interconnect Express (PCI-E) interface.
